(19) United States
(12) Patent Application Publication
(10) Pub. No.: US 2004/0139471 A1
(43) Pub. Date: Jul. 15, 2004

(54) Systems and methods for providing interactive video response to wireless terminals

(75) Inventors: David W. Geen, Beaverdam, VA (US); Jingyi Hu, Glen Allen, VA (US); Pareshkumar J. Lukka, Richmond, VA (US); Priti D. Patil, Richmond, VA (US); Sujay H. Telang, Richmond, VA (US); Gerald G. Washington, Glen Allen, VA (US)

Correspondence Address: Finnegan, Henderson, Farabow,, Garrett & Dunner, L.L.P., 1300 I Street, N.W., Washington, DC, 20005-3315, US

(73) Assignee: LogicaCMG Wireless Networks, Inc.

(21) Appl. No.: 10/742,795

(22) Filed: Dec. 23, 2003

Related U.S. Application Data
(60) Provisional application No. 60/436,477, filed on Dec. 27, 2002.

(51) Int. Cl. H04N 7/173; H04N 7/16

(52) U.S. Cl. 725/106; 725/62; 725/105

(57) ABSTRACT

Interactive video call response system that can provide a video greeting and an option to deposit a video message to a video capable wireless terminal, such as a third generation compatible wireless terminal, is provided. A user of the video capable wireless terminal is provided a video greeting when a recipient of the video call does not answer. The user may deposit a video message for a user of another wireless terminal. The recipient of the video call may later retrieve any deposited video message(s) using any device capable of retrieving deposited video messages.

### DESCRIPTION OF THE INVENTION

This application claims priority under 35 U.S.C. § 119 based on U.S. Provisional Application No. 60/436,477, filed Dec. 27, 2002, the complete disclosure of which is incorporated herein by reference.

### FIELD OF THE INVENTION

This invention relates to communications systems and methods, and more particularly, it relates to systems and methods for providing interactive video response to wireless terminals.

### BACKGROUND OF THE INVENTION

Wireless cellular telecommunication systems have evolved from analog systems, such as AMPS and TACS to digital systems, such as CDMA, TDMA, and GSM. These first two generations of wireless cellular telecommunication systems are now being replaced by the third generation systems (also referred to as 3G systems). While the first generation of wireless cellular telecommunication systems largely focused on providing voice communications, the second generation targeted data communications, as well. The third generation aims for handling richer content, such as multimedia and video messaging. Third generation wireless cellular telecommunication systems are expected to bring high-speed wireless connectivity to cellular communications enabling new applications, such as video messaging.

Evolution from one generation of wireless cellular telecommunication systems to another, however, has been problematic in terms of providing support for interactive services, such as interactive voice response to wireless terminals. Thus, for example, current systems provide interactive voice response to voice capable wireless terminals, but do not provide any interactive response to video capable wireless terminals.

Accordingly, there is a need for systems and methods for providing interactive video response to wireless terminals.

### SUMMARY OF THE INVENTION

In accordance with the invention, systems and methods for providing interactive video response to wireless terminals are provided. Thus, for example, a video capable wireless terminal, such as a third generation compatible wireless terminal may be provided a video greeting when a recipient of a video call does not answer. The recipient of the video call may later retrieve any deposited video message(s) by the caller.

Accordingly, one exemplary embodiment of the present invention relates to a method for providing interactive video response to a user of a first wireless terminal. The method may include receiving a call signal from the first wireless terminal for a second wireless terminal. The method may further include forwarding the call signal to a video call response system upon determining the call signal corresponds to a video call, in an absence of a response by a user of the second wireless terminal to the video call.

In another embodiment consistent with the present invention, a method for providing interactive video response to a user of a first wireless terminal is provided. The method may include receiving a call signal from the first wireless terminal for a second wireless terminal. The method may further include determining whether the call signal corresponds to a video call. The method may further include providing a video greeting to the user of the first wireless terminal if the call signal corresponds to the video call, in an absence of a response by a user of the second wireless terminal.

In yet another embodiment consistent with the present invention, a system for providing interactive video response to a user of a first wireless terminal is provided. The system may include at least one mobile switching center for receiving a call signal from the first wireless terminal. The system may further include a call routing module to route the call signal to a voice response system or a video response system depending upon whether the call signal corresponds to a voice call or a video call, respectively.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments of the invention and together with the description, serve to explain the principles of the invention. In the drawings,

FIG. 1 shows one embodiment of an exemplary system for providing interactive video response consistent with the present invention;

FIG. 2 shows one embodiment of a video call response system of FIG. 1 consistent with the present invention;

FIG. 3 shows one embodiment of a call routing module consistent with the present invention;

FIG. 4 shows a flow chart for an exemplary method for providing interactive video response to a user of a wireless terminal consistent with the present invention; and

FIG. 5 shows a flow chart for another exemplary method for providing interactive video response to a user of a wireless terminal consistent with the present invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

In accordance with the invention, systems and methods for providing interactive video response to wireless terminals are provided. For example, a video capable wireless terminal, such as a third generation compatible wireless terminal, may be provided a video greeting when a recipient of a video call does not answer. The recipient of the video call may later retrieve any deposited video message(s) from the caller(s).

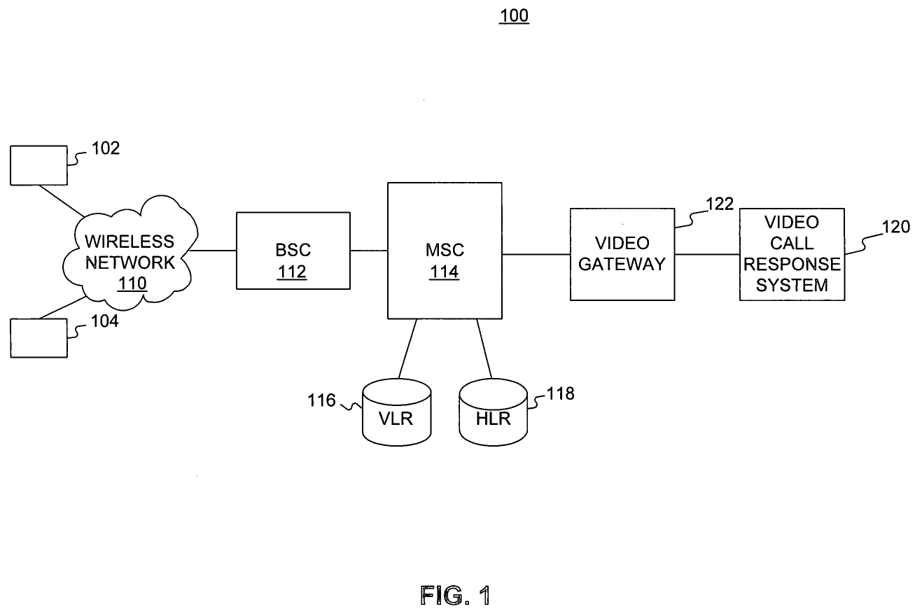

FIG. 1 shows an exemplary system 100 consistent with one embodiment of the present invention. As shown, exemplary system 100 may include wireless terminals 102 and 104 connected to a base station controller (BSC) 112 via a wireless network 110. In one embodiment, wireless terminals 102 and 104 may be third generation (3G) videophones and wireless network 110 may be a 3G network. Thus, using wireless terminal 102, a user may make a video call to a user of another wireless terminal, such as video capable wireless terminal. As discussed further below, if the user of the other wireless terminal does not answer, then the video call may be forwarded to a video call response system.

Base station controller 112 may further be connected to a mobile station controller (MSC) 114. Mobile station controller 114 may be connected to a visitor location register 116 (VLR) and a home location register (HLR) 118. HLR 118 may be a database used to store information concerning a wireless terminal's user, such as account status and user preferences. In one embodiment, HLR 118 may further store information concerning a wireless terminal's functionality. Wireless terminal functionalities stored in HLR 118 may relate to whether a particular wireless terminal can handle video calls or process multimedia, for example. HLR 118 may also contain information that uniquely identifies a particular wireless terminal, such as its International Mobile Subscriber Number (IMSI) or its Electronic Serial Number (ESN). VLR 116 may be a database used to store similar information concerning roaming users. Although FIG. 1 shows only one exemplary base station controller and one mobile station controller, one may have additional base station controllers and/or mobile station controllers. Further, the functionality of a base station controller and a mobile station controller may be combined in one component, if necessary. Similarly, exemplary system 100 may include additional home location and visitor location registers.

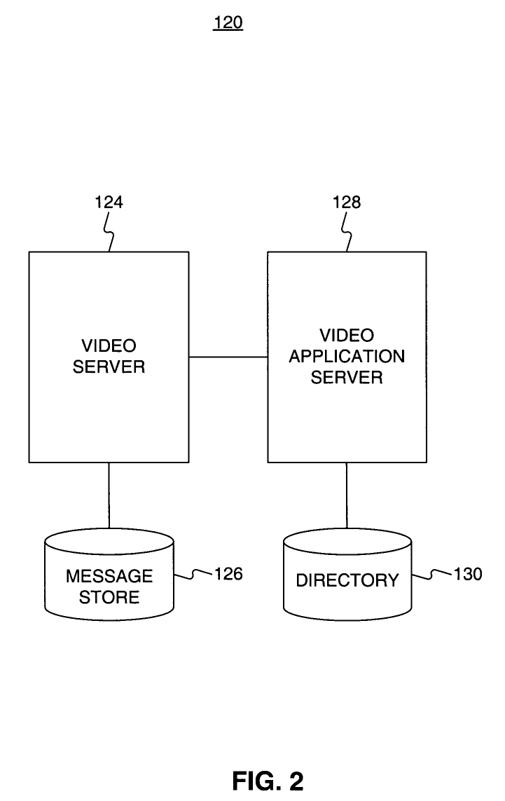

In addition, mobile station controller 114 may be coupled to a video call response system 120 through a video gateway 122. Video call response system 120 may provide interactive video response to a user of a video capable wireless terminal. Thus, for example, video call response system 120 may provide a video greeting to a user of a video capable wireless terminal when the called party does not answer. An exemplary video call response system 120 is further described with respect to FIG. 2, further below. Mobile station controller 114 may be further coupled to a voice response system (not shown) through a voice gateway (not shown). Voice response system may provide interactive voice response to a user of a wireless terminal.

An exemplary video gateway 122 may allow video capable wireless terminals, such as H.324 protocol (a standard protocol from International Telecommunications Union, located at Geneva Switzerland) compatible terminals, to communicate with other wireless terminals by converting protocols and transcoding, as necessary. Transcoding may involve converting a circuit-switched call, such as a wireless call on a conventional wireless network, into a packet-switched call, such as a call repackaged into IP-packets. In one embodiment, a video gateway may be implemented using an Ericsson Site Keeper, an Ericsson Media Gateway Controller, and an Ericsson Media Gateway available from Ericsson of Stockholm, Sweden. Video gateway 122 may be connected via a network, such as the IP network, to video response system 120. Further, although not shown in FIG. 1, H.323 protocol (a standard protocol from International Telecommunications Union, located at Geneva Switzerland) compatible terminals, such as PC videophones and conventional videophones may be connected via the Internet or an Intranet to video gateway 122. In this embodiment, an Ericsson Terminal Adapter (not shown) available from Ericsson of Stockholm, Sweden, may be used to interface a PC videophone with video gateway 122. The Ericsson Terminal Adapter may enable calling from PC videophones (H.323 compatible or SIP (session initiation protocol available from Internet Engineering Task Force) compatible videophones, for example) to mobile videophone handsets. Similarly, a videophone may be connected using an Integrated Digital Services Network (ISDN) to video gateway 122. Video gateway 122 may provide transcoding and protocol conversion, as necessary (for example, from H.320 protocol to H.323 protocol, or vice versa).

As shown in FIG. 2, an exemplary video call response system 120 may include a video server 124, a message store 126, a video application server 128, and a directory 130. Video server 124 may terminate video calls and set up a channel between video server 124 and video application server 128. In one embodiment, video server 124 may be implemented using a Sun Fire v120 server (available from Sun Microsystems of Santa Clara, Calif.) augmented with a CG6000 digital signal processing (DSP) board available from NMS Communications of Framingham, Mass. Video server 124 may retrieve video greetings and/or video messages from message store 126, as discussed further below. In one embodiment, message store 126 may be implemented as an Internet Mail Access Protocol (IMAP) server, such that video server 124 may communicate with message store 126 using IMAP commands.

Video application server 128 may be implemented using an Apache web server software available from the Apache Software Foundation. Any suitable hardware platform may be used to run video application server 128. In one embodiment, video application server 128 may communicate with video server 124 and receive the calling wireless terminal's phone number, the called wireless terminal's phone number, and a phone number to which the call is redirected in the absence of a response from the called party. Video application server 128 may then locate the called party in directory 130 using the calling wireless terminal's phone number, the called wireless terminal's phone number, and the phone number to which the call is redirected to in the absence of the response from the called party. Alternatively, the called wireless terminal's phone number may alone be used to locate the called party in directory 130. In one embodiment, directory 130 may be a directory compatible with the Light Weight Directory Access Protocol. Once the called party is located, called party's user preferences associated with, for example, a type of greeting that should be played to a caller or a set of callers may be retrieved. The user preferences may be stored in directory 130 or another data store. The type of greeting to be played to a caller may be selected from a list including, a default greeting, an all-calls greeting, a busy greeting, a no-answer greeting, and an extended-absence greeting.

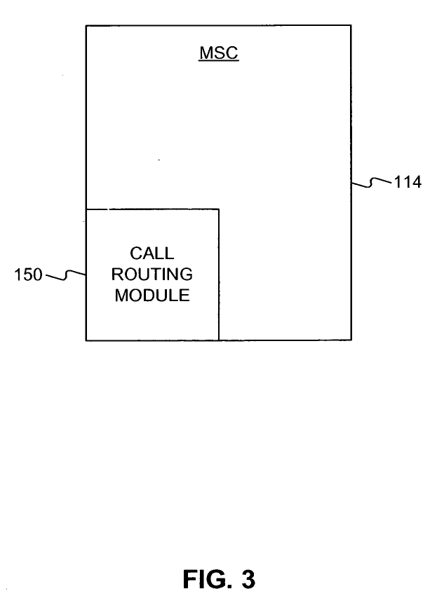

As shown in FIG. 3, in one embodiment, mobile station controller (MSC) 114 may include a call routing module 150, which may be used consistent with the method for providing interactive video response to a caller. Call routing module 150 may route voice calls to a voice response system (not shown) and video calls to video call response system 120. In one embodiment, as part of this process call routing module 150 may determine, in an absence of a response by a user of a second wireless terminal to call, whether the call signal corresponds to a video call by analyzing bearer capability information in the call signal. Thus, for example, call routing module 150 may analyze an ISDN information element used to describe bearer services, such as data rate required for that call. A higher data rate may indicate that the call corresponds to a video call. Other techniques may also be used to determine whether the call signal corresponds to a video call. For example, in another embodiment, address information related to the call signal, such as the telephone number of the second wireless terminal (the called party) may be analyzed to determine whether the call is a video call. This may be accomplished by identifying telephone numbers as being associated with a video capable wireless terminal or a voice only terminal. Information concerning the nature of wireless terminals—video capable or voice only capable—may be stored in VLR 116 and/or HLR 118. Call routing module 150 may forward the call signal to video call response system 120 after querying VLR 116 and/or HLR 118, in an absence of a response by a user of the second wireless terminal. Alternatively, call routing module 150 may route the call to a voice response system (not shown).

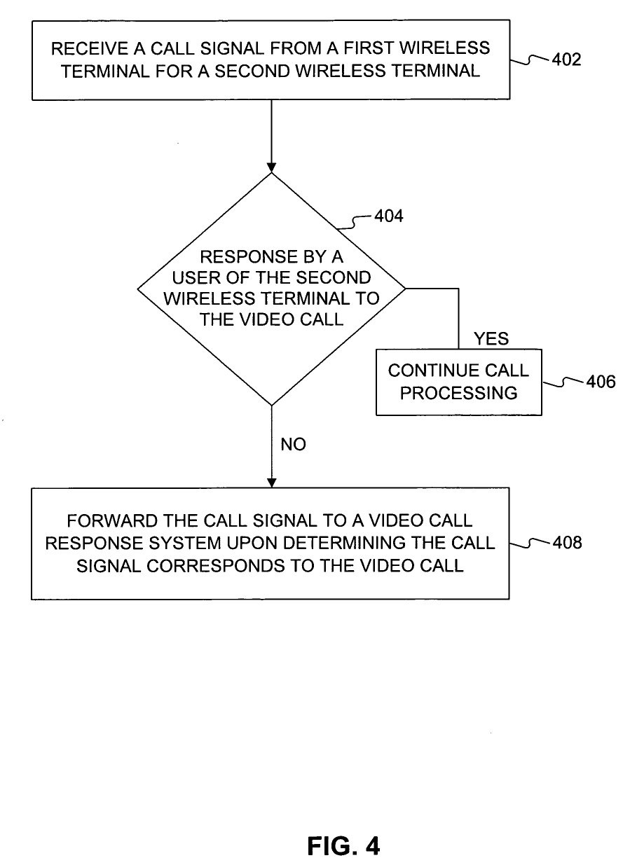

FIG. 4 shows a flow chart, consistent with the present invention, for an exemplary method for providing interactive video response to a user of a first wireless terminal. For illustrative purposes, the first wireless terminal may originate a call signal to establish a call between the first wireless terminal and the second wireless terminal. The call signal may be received by a mobile switching center 114 via a base station controller 112. Thus, the first step of the method may involve a call routing module 150 receiving a call signal from the first wireless terminal for a second wireless terminal (step 402). In one embodiment, the first wireless terminal may be a H.324m protocol (a standard protocol from International Telecommunications Union, located at Geneva Switzerland) or 3G-324 protocol compliant mobile phone handset. Of course, any other wireless terminal that can handle video calls may also be used.

Call routing module 150 may then determine, alone or in combination with other components of mobile switching center 114, whether there is a response by a user of the second wireless terminal (step 404). If the user of the second wireless terminal responds, then call processing may continue (step 406), including, for example, maintaining the call connection until any one of the users terminates the call. If, however, the user of the second wireless terminal does not respond, then call routing module 150 forwards the call to a video call response system 120 upon determining the call signal corresponds to a video call, in an absence of a response by a user of the second wireless terminal to the video call (step 408). As part of this step, call routing module 150 may analyze bearer capability information in the call signal. Thus, for example, call routing module 150 may analyze an ISDN information element used to describe bearer services, such as data rate required for the call. A higher data rate may indicate that the call corresponds to a video call. Other techniques may also be used to determine whether the call signal corresponds to a video call. For example, in another embodiment, address information related to the call signal, such as the telephone number of the second wireless terminal (the called party) may be analyzed to determine whether the call is a video call. This may be accomplished by identifying telephone numbers as being associated with a video capable wireless terminal or a voice only terminal. Information concerning the nature of wireless terminals—video capable or voice only capable—may be stored in VLR 116 and/or HLR 118. Call routing module 150 may forward the call signal to video call response system 120 after querying VLR 116 and/or HLR 118, in an absence of a response by a user of the second wireless terminal. In one embodiment, VLR database 116 or HLR database 118 may be queried by using the International Mobile Subscriber Number (IMSI) associated with a particular wireless terminal, such as the second wireless terminal. Of course, other fields, such as an Electronic Serial Number (ESN) associated with a wireless terminal may also be used to query the relevant database(s).

Once the call signal is forwarded to video call response system 120, in one embodiment, video call response system 120 may provide the user of the first wireless terminal an option to deposit a video message for the user of the second wireless terminal. As part of this step, video call response system 120 may play a greeting to the user of the first wireless terminal. In one embodiment, video application server 128 may communicate with video server 124 and receive the calling wireless terminal's phone number, the called wireless terminal's phone number, and a phone number to which the call is redirected to in the absence of a response from the user of the called party. Video application server 128 may then locate information corresponding to the called party in directory 130 using the calling wireless terminal's phone number, the called wireless terminal's phone number, and the phone number to which the call is redirected to. Alternatively, in another embodiment, the called wireless terminal's phone number may alone be used to locate information corresponding to the called party in directory 130. In one embodiment, directory 130 may be a directory compatible with the Light Weight Directory Access Protocol. Video application server 128 may retrieve information corresponding to the called party, including for example, user preferences specifying a type of greeting that should be played to a caller or a set of callers. The user preferences may be stored in directory 130 or another data store. The type of greeting to be played to a caller may be selected from a list including, a default greeting, an all-calls greeting, busy greeting, no-answer greeting, and an extended-absence greeting.

Once voice call response system 120 has provided the greeting to the user, the user may deposit a video message for the user of the second wireless terminal. Video server 124 may encode the video message in a suitable format, and the encoded video message may be forwarded by video server 124 to message store 126. In one embodiment, the video message may be encoded into a Multipurpose Internet Mail Extension (MIME, a standard Internet protocol) and forwarded via Simple Mail Transport Protocol (SMTP, a standard Internet protocol) to message store 126.

The recipient of a the video message, such as the user of the second wireless terminal may be notified by video server 124 using techniques, such as short message service (SMS), multimedia message service (MMS), or paging. Video application server 124 may notify the user of the second wireless terminal immediately upon receipt of a video message or it may notify the user periodically.

Consistent with the present invention, the user of the second wireless terminal may retrieve the deposited video message using any video communication capable device, such as the second wireless terminal, a personal computer, a personal digital assistant, or any other appliance capable of retrieving an electronic message. As part of the retrieval process for the deposited video message from message store 126, video application server 128 may locate a message store account for the user of the second wireless terminal and then video server 124 may retrieve the deposited video message. Video application server 128 may locate the message store account by accessing directory 130, for example, to retrieve message store account information associated with the telephone number of the second wireless terminal. Next, video server 124, having received message store account information for the user of the second wireless terminal, may retrieve stored messages for the user of the second terminal using any of the variety of message retrieval systems and programs used for retrieving messages stored in a message store, such as Internet Mail Access Protocol (IMAP). Video server 124 may then deliver the stored video message(s) to video gateway 122, which may then deliver the video message to the device, such as the second wireless terminal, being used by the user to retrieve the deposited message(s).

In one embodiment, the user of the second wireless terminal may be presented with a list of messages, including, for example, new video messages. The user may then parse through the list of messages and select any or all of the messages for viewing by pressing various combinations of keys, as directed by video response system 120. Dual Tone Multi-Frequency (DTMF) signals from the user's wireless terminal or another similar device may be processed by video server 124, which may in turn retrieve appropriate messages from message store 126.

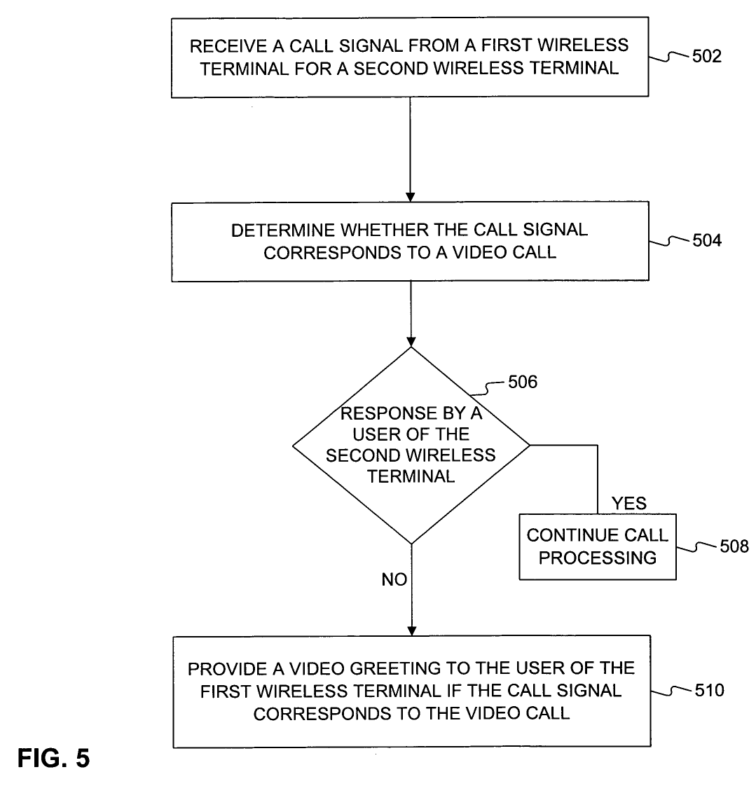

FIG. 5 shows a flow chart, consistent with the present invention, for another exemplary method for providing interactive video response to a user of a wireless terminal. The exemplary method may include call routing module 150 receiving a call signal from a first wireless terminal for a second wireless terminal (step 502). In one embodiment, the first wireless terminal may be a H.324m protocol (a standard protocol from International Telecommunications Union, located at Geneva Switzerland) or 3G-324 protocol compliant mobile phone handset. Of course, any other wireless terminal that can handle video calls may also be used.

The next step may involve determining whether the call signal corresponds to a video call or a voice call (step 504). As part of this step, call routing module 150 may analyze bearer capability information in the call signal. Thus, for example, call routing module 150 may analyze an ISDN information element used to describe bearer services, such as data rate required for that call. A higher data rate may indicate that the call corresponds to a video call. Other techniques may also be used to determine whether the call signal corresponds to a video call. For example, in another embodiment, address information related to the call signal, such as the telephone number of the second wireless terminal (the called party) may be analyzed to determine whether the call is a video call. This may be accomplished by identifying telephone numbers as being associated with a video capable wireless terminal or a voice only terminal. Information concerning the nature of wireless terminals—video capable or voice only capable—may be stored in VLR 116 and/or HLR 118. Call routing module 150 may forward the call signal to video call response system 120 after querying VLR 116 and/or HLR 118, in an absence of a response by a user of the second wireless terminal. In one embodiment, VLR database 116 or HLR database 118 may be queried by using the International Mobile Subscriber Number (IMSI) associated with a particular wireless terminal, such as the second wireless terminal. Of course, other fields, such as an Electronic Serial Number (ESN) associated with a wireless terminal may also be used to query the relevant database(s).

Next, call routing module 150 may determine, alone or in combination with other components of mobile switching center 114, whether there is a response by a user of the second wireless terminal (step 506). If the user of the second wireless terminal responds, then call processing may continue (step 508), including, for example, maintaining the call connection until any one of the users terminates the call. If, however, the user of the second wireless terminal does not respond, then video call response system 120 provides a video greeting to the user of the first wireless terminal if the call signal corresponds to the video call (step 510). In one embodiment, video application server 128 may communicate with video server 124 and receive the calling wireless terminal's phone number, the called wireless terminal's phone number, and a phone number to which the call is redirected to in the absence of a response from the user of the called party. Video application server 128 may then locate information corresponding to the called party in directory 130 using the calling wireless terminal's phone number, the called wireless terminal's phone number, and the phone number to which the call is redirected to in the absence of the response from the called party. Alternatively, in another embodiment, the called wireless terminal's phone number may alone be used to locate information corresponding to the called party in directory 130. In one embodiment, directory 130 may be a directory compatible with the Light Weight Directory Access Protocol. Information corresponding to the called party may include user preferences associated with, for example, a type of greeting that should be played to a caller or a set of callers may be retrieved. The user preferences may be stored in directory 130 or another data store. The type of greeting to be played to a caller may be selected from a list including, a default greeting, an all-calls greeting, a busy greeting, a no-answer greeting, and an extended-absence greeting.

Other embodiments of the invention will be apparent to those skilled in the art from consideration of the specification and practice of the invention disclosed herein. For example, a component other than the mobile station controller and/or the video gateway may be used to process communication consistent with the present invention. It is intended that the specification and examples be considered as exemplary only, with a true scope and spirit of the invention being indicated by the following claims.

What is claimed is:

1. A method for providing interactive video response to a user of a first wireless terminal, the method comprising:
receiving a call signal from the first wireless terminal for a second wireless terminal; and
forwarding the call signal to a video call response system upon determining the call signal corresponds to a video call, in an absence of a response by a user of the second wireless terminal to the video call.

2. The method of claim 1, wherein determining the call signal corresponds to the video call further comprises analyzing bearer capability information in the call signal.

3. The method of claim 1, wherein determining the call signal corresponds to the video call further comprises analyzing address information in the call signal.

4. The method of claim 1 further comprising providing a video greeting to the user of the first wireless terminal.

5. The method of claim 4, wherein a type of greeting to be provided to the user of the first wireless terminal is selected from a list including, a default greeting, an all-calls greeting, a busy greeting, a no-answer greeting, and an extended-absence greeting.

6. The method of claim 1 further comprising providing the user of the first wireless terminal an option to deposit a video message for the user of the second wireless terminal.

7. The method of claim 6 further comprising providing the user of the second wireless terminal an option to retrieve the deposited video message.

8. The method of claim 6, wherein the video message is encoded and forwarded to a message store.

9. The method of claim 8, wherein the video message is encoded into a multipurpose Internet mail extension format and forwarded via simple mail transport protocol to the message store.

10. The method of claim 7 further comprising locating a message store account for the user of the second wireless terminal and retrieving the deposited video message from the message store for the user of the second wireless terminal.

11. The method of claim 1 further comprising upon determining the call signal corresponds to a voice call, in an absence of a response by the user of the second wireless terminal to the voice call, forwarding the call signal to a voice call response system.

12. A system for providing interactive video response to a user of a first wireless terminal, the system comprising:
means for receiving a call signal from the first wireless terminal for a second wireless terminal;
means for determining whether the call signal corresponds to a video call; and
means for forwarding the call signal to a video call response system upon determining that the call signals corresponds to the video call, in an absence of a response by a user of the second wireless terminal to the video call.

13. The system of claim 12, wherein means for determining whether the call signal corresponds to the video call further comprises means for analyzing bearer capability information in the call signal.

14. The system of claim 12, wherein means for determining whether the call signal corresponds to the video call further comprises means for analyzing address information in the call signal.

15. The system of claim 12 further comprising means for providing a video greeting to the user of the first wireless terminal.

16. The system of claim 15, wherein a type of greeting to be provided to the user of the first wireless terminal is selected from a list including, a default greeting, an all-calls greeting, a busy greeting, a no-answer greeting, and an extended-absence greeting.

17. The system of claim 12 further comprising means for providing the user of the first wireless terminal an option to deposit a video message for the user of the second wireless terminal.

18. The system of claim 17 further comprising means for providing the user of the second wireless terminal an option to retrieve the deposited video message.

19. The system of claim 17, wherein the video message is encoded and forwarded to a message store.

20. The system of claim 19, wherein the video message is encoded into a multipurpose Internet mail extension format and forwarded via simple mail transport protocol to the message store.

21. The system of claim 18 further comprising means for locating a message store account for the user of the second wireless terminal and retrieving the deposited video message from the message store for the user of the second wireless terminal.

22. A method for providing interactive video response to a user of a first wireless terminal, the method comprising:
receiving a call signal from the first wireless terminal for a second wireless terminal;
determining whether the call signal corresponds to a video call; and
in an absence of a response by a user of the second wireless terminal, providing a video greeting to the user of the first wireless terminal if the call signal corresponds to the video call.

23. The method of claim 22, wherein determining whether the call signal corresponds to the video call further comprises analyzing bearer capability information in the call signal.

24. The method of claim 22, wherein determining whether the call signal corresponds to the video call further comprises analyzing address information in the call signal.

25. A system for providing interactive video response to a user of a first wireless terminal, the system comprising:
means for receiving a call signal from the first wireless terminal for a second wireless terminal;
means for determining whether the call signal corresponds to a video call; and
means for providing a video greeting to the user of the first wireless terminal if the call signal corresponds to the video call, in an absence of a response by a user of the second wireless terminal.

26. The system of claim 25, wherein means for determining whether the call signal corresponds to the video call further comprises means for analyzing bearer capability information in the call signal.

27. The system of claim 25, wherein means for determining whether the call signal corresponds to the video call further comprises means for analyzing address information in the call signal.

28. A system for providing interactive video response to a user of a first wireless terminal, the system comprising:
at least one mobile switching center for receiving a call signal from the first wireless terminal; and
a call routing module to route the call signal to a voice response system or a video response system depending upon whether the call signal corresponds to a voice call or a video call, respectively.

29. The system of claim 28 further comprising a video gateway.

30. The system of claim 28, wherein the video call response system further comprises a video server and a message store for storing video messages.

31. The system of claim 28, wherein the video call response system further comprises a video application server and a directory for storing user preferences for users of the video call response system.

32. The system of claim 31, wherein the stored user preferences relate to a type of greeting to be played to a caller, the type of greeting selected from a list including, a default greeting, an all-calls greeting, a busy greeting, a no-answer greeting, and an extended-absence greeting.
